(19) United States
(12) Patent Application Publication
(10) Pub. No.: US 2015/0123836 A1
(43) Pub. Date: May 7, 2015

(54) OBSTACLES DETECTION SYSTEM

(71) Applicant: Radar Obstacle Detection LTD., Hod Hasharon (IL)

(72) Inventors: Haim Niv, Hod Hasharon (IL); Alon Slapak, Hod Hasharon (IL); Marc Zuta, Petah Tikva (IL)

(21) Appl. No.: 14/397,862

(22) PCT Filed: May 1, 2013
(86) PCT No.: PCT/IL2013/000043

§ 371 Date: Oct. 30, 2014

(30) Foreign Application Priority Data
May 2, 2012 (IL) 219547

(51) Int. Cl. G01S 13/04; G01S 7/02

(52) U.S. Cl. CPC G01S 13/04; G01S 7/02
USPC 342/27

(57) ABSTRACT

A wire detection apparatus comprises antenna means with a transmitter and a receiver, so devised as to form a pulsed radar system, further including polarization control means for controlling the polarization of waves transmitted and/or received through the antenna means, and processing means for identifying returns from wires according to wires' characteristic polarization echoes. The transmitted waves have a wavelength longer than the diameter of wires to be detected and identified. The transmitted waves preferably have a wavelength more than six times longer than the diameter of wires to be detected and identified. The apparatus is so devised as to detect wires suspended in the air.

### TECHNICAL FIELD

The present invention relates to systems for detection of wires and pylons, and more particularly to such systems using polarized radio waves.

### BACKGROUND ART

The present application claims priority from patent application No. 219547 filed in Israel by the present applicant, Obstacles Detection Radar Ltd., on 2 May 2012. Heretofore, various systems were devised for detecting suspended wires, which form an obstacle for helicopters and for low flying light aircraft. Wires may include high voltage power cables, medium voltage cables, telephone cables and more.

Helicopters may collide with these wires, with fatal consequences. The problem is that it is difficult to see wires from the air, on the dark background of the ground. This is difficult at daytime in a good weather. It is impossible to see wires at night or in bad weather.

Suspended wires are more dangerous to helicopters than other ground obstacles. Ground obstacles usually have a relatively small width and height, whereas wires are located higher and span a large width, so the danger of collision with wires is much higher. Therefore, it is important to distinguish suspended wires from other ground reflectors and to warn the pilot accordingly.

Prior art sensor systems apparently do not detect wires effectively.

These include, for example, millimeter wave radar, laser radar, FLIR and more. These prior art systems are complex, heavy and costly and only achieve a limited success in detecting wires.

There is a need for a light weight, low cost, simple structure system for wire detection and pilot warning.

A prior patent (U.S. Pat. No. 6,278,409), granted to one of the present applicants, discloses a system for detecting wires using polarization.

Basically this prior art system includes a transmitter for transmitting multi-polarity waves, means for receiving waves reflected off target and means for analyzing the polarization of the reflected waves to detect linearly polarized echoes characteristic of wires and to issue a warning indicative of the presence of a wire. The wavelength of the transmitted waves is larger than the diameter of the wires to be detected.

A possible problem with a practical implementation of this system is the conflicting requirements for a low operating frequency to distinguish wires from ground clutter; and high resolution to reduce the ground clutter return, which requires a large bandwidth.

That is, if the radar is so devised as to operate at a low frequency, it is difficult or impossible to simultaneously achieve high resolution.

Another possible problem is that, in some real-life situations, there may not be a broadside return normal to the wire, as illustrated in FIG. 1A. In other situations the desired broadside return will be available, FIG. 1B.

In the case as illustrated in FIG. 1A, there is a radar reflection from a pylon 18. This reflection can advantageously be used to indicate, indirectly, a possible danger of wires in the area; but only if the reflection can be identified as that from a pylon. If the wavelength used is smaller than the width of the pylon, the pylon will return waves in all polarizations, so it may be indistinguishable from other ground reflectors.

To distinguish a pylon, a still lower transmit frequency is required:

Whereas for wires identification the wavelength should be larger than the wire diameter of about 2.5 centimeters (cm), for pylons identification the wavelength should be larger than about 1-2 meters (m).

Such a long wavelength (low frequency) requires a large transmit/receive antenna, clearly an undesired situation in a helicopter or light aircraft. Moreover, a low operating frequency further reduces the radar resolution.

Following is a description of prior art systems for wire detection.

Thurlow, U.S. Pat. No. 5,264,856, discloses a system and method for detecting radiant energy reflected by a length of wire. The system has two antennas that transmit and receive at two fixed polarizations.

Kennedy, U.S. Pat. No. 4,737,788, discloses a helicopter obstacle detector using a pulsed Doppler radar. A transmit/receive antenna is mounted near the tip of the helicopter's rotor blade for sensing obstacles.

An airborne obstacle collision avoidance apparatus is disclosed in U.S. Pat. No. 5,448,233 by Izhak Saban et al. The apparatus includes an object sensor for sensing objects within a field of view of the aircraft and an aircraft navigation system. Israel patent No. 104542.

Israel application No. 109392 assigned to Northrop Grumman Corporation, discloses a system for sensing objects in the flight path of an aircraft. The system comprises means in the form of a laser radar subsystem for emitting a beam of laser energy, for receiving returns from objects, and for processing the returns.

Israel application No. 110741 assigned to United Technologies Corporation, discloses a wire cutter system having aerodynamic, microwave energy absorbing fairing. The system includes wire cutter means and a fairing for covering the cutter means.

U.S. Pat. No. 5,465,142 by Krumes et al., discloses a system for sensing objects in the flight path of an aircraft and alerting the pilot to their presence.

The system includes a laser radar subsystem for emitting a beam of laser energy, receiving returns from objects, and processing the returns.

U.S. Pat. No. 5,371,581 by Wangler et al., discloses a helicopter obstacle warning system includes a horizontally rotating beam from a laser rangefinder which detects and measures the distance to ground objects which may present a hazard to a helicopter during hover, takeoff and landing.

U.S. Pat. No. 4,528,564 by Trampnau, discloses a warning device for helicopters with a tail rotor and a mechanical protection device therefor. The warning device comprises a height-finder with a transmitting/receiving antenna mounted at the helicopter tail to produce a height-finding beam.

U.S. Pat. No. 5,210,586 by Ludger et al., discloses an arrangement for recognizing obstacles for pilots of low-flying aircraft. The system includes a pulsed laser range finder for scanning a given field of view and for the pictorial presentation of the course of a perceived obstacle.

EP 391328 A2 by Giulio et al., discloses an obstacle detection and warning system particularly well suited for helicopter applications. The system includes a laser emitter which scans the surrounding space by means of an acousto-optical deflector.

U.S. Pat. No. 5,451,957 by Klausing, discloses a radar device for obstacle warning. A radar device has a synthetic aperture based on rotating antennae preferably for helicopters, which operates in the millimeter-wave range and is used mainly as an obstacle radar.

U.S. Pat. No. 4,695,842 by Jehle et al., discloses an aircraft radar arrangement, particularly for helicopters. A dual frequency system uses a first frequency of 60 GHz for obstacle warning, and a second frequency of 50 GHz for moving target detection and navigation.

U.S. Pat. No. 4,902,126 by Koechner, discloses a wire obstacle avoidance system for helicopters which includes a solid state laser transmitter which emits radiation in the near infrared wavelength region. The return signals are compared with the transmitted laser lobes. The range information is displayed to the pilot who then takes evasive action.

U.S. Pat. No. 4,572,662 by Silverman et al., discloses a wire and wire like object detection system. An optical radar operating in the infrared region of the spectrum and add to efficiently detect elongated targets such as wires. The pulsed transmitter is preferably passively Q-switched and produces optical pulses polarized in one direction.

U.S. Pat. No. 4,417,248 assigned to Westinghouse Electric Corp., discloses an adaptive collision threat assessor including a monopulse radar with a system to adaptively assess a detected threat in accordance with the relative bearing representative measurements thereof.

These are used to determine the collision potential of the threat with the radar. A comparison test is conducted at each of the selected number of time increments.

U.S. Pat. No. 4,638,315 by Raven et al., discloses a rotor tip synthetic aperture radar including a rotor, a radar receiver positioned in the rotor and for relaying received signals to a second position such as the cab of a helicopter.

U.S. Pat. No. 5,296,909 by Fazi et al., discloses a detector of suspended cables for avionics applications. The system includes a scanning system with a noise generator and scan concentrator, a LIDAR system and an extractor system.

U.S. Pat. No. 4,362,992 by Young et al., discloses a system and method of detecting the proximity of an alternating magnetic field, such as that emanating from power transmission cables.

U.S. Pat. No. 4,068,124 by Kleider, discloses a wire obstacle warning system. The system includes a linear CCD sensor array included in the gated optical radar which is particularly adapted to permit pattern recognition of wire or wire-like obstacles during low-level flight of the radar platform, e.g. helicopters or the like.

U.S. Pat. No. 5,486,832 by Hulderman, discloses a radar apparatus that includes a millimeter-wave radar transmitter comprising a flood beam antenna, and a radar signal processor for processing radar return signals to produce radar output signals.

An RF sensor comprising a receive antenna includes a plurality of antenna elements, a plurality of respectively coupled to outputs of the plurality of antenna elements and coupled to the transmitter.

U.S. Pat. No. 5,047,779 by Hager, discloses an aircraft radar altimeter with multiple target tracking capability. The radar includes a programmed microcontroller which permits effective simultaneous tracking of at least two targets such that, for example, both ground and obstacles on the ground can be simultaneously tracked, thus avoiding crashes.

U.S. Pat. No. 5,442,556 by Boyes et al., discloses an aircraft terrain and obstacle avoidance system. The system generates in the aircraft a warning signal when the aircraft is on a potentially hazardous course. The system involves the computation of pull-up trajectories which the aircraft could carry out at a reference point on the current aircraft flight path.

### DISCLOSURE OF INVENTION

The present invention discloses a new system for detection of wires using polarized radio waves. The wires are suspended wires, especially electricity wires between pylons. Telephone and other suspended wires may be detected as well.

According to one aspect of the invention, the system transmits multi-polarity waves, that is waves that have more than one linear polarization component. For each transmitted polarization, a receiver in the system analyzes the received echoes to detect linear polarized waves that are characteristic of wires.

In one embodiment, linearly polarized waves are transmitted and the polarization of received waves is measured. Linearly polarized echoes are indicative of a wire in the area.

In another embodiment, linearly polarized waves are transmitted and the same 10 polarization is used to receive reflected waves. The variations in the reflected waves with respect to the transmit/receive polarization, are indicative of the presence of a wire.

Antennas with polarization control capability are used, that are capable of 15 transmitting and receiving waves at a desired polarization, together with radar transmitter means and receiver means.

In a preferred embodiment, the radar transmits a linearly polarized wave and receives waves with the same polarization orientation. This achieves a better polarization selectivity.

According to a second aspect of the invention, antennas with polarization control capability are installed in a helicopter or airplane to provide forward detection capability and, in addition, optional lateral detection capability.

The system uses waves having a wavelength that is longer than the diameter of the wires to be detected, to stimulate and exploit the polarization properties of thin wires.

According to another aspect of the invention, a still longer wavelength is used, which is longer than the diameter (or width) of pylons. Such signals cause a polarized waves reflection off pylons, thus allowing to distinguish pylons from the background.

A dual frequency system may use a higher frequency for detecting wires, wherein the wavelength is determined by the wires diameter; and a lower frequency for detecting pylons, wherein the wavelength is determined by the pylon width. Each combination (frequency, transmit signal waveform and signal processing) is optimized for one of the expected targets: wires and pylons.

The new system may alternately perform cycles of wires and pylons detection; the results may be combined and correlated for an overall threat evaluation and alarm issuance to pilot.

Signal processing may further distinguish wires and pylons from their polarization orientation, which is close to horizontal for wires and close to vertical for pylons.

Interferometer means may improve the measurement of the direction to wires and pylons; a plurality of elements may be used to form a wide or omnidirectional transmit pattern, and narrower beams with directionality at receive. Directionality may be in one dimension (azimuth) or two dimensions (azimuth and elevation).

The direction to wire from an interferometer can be correlated with the doppler measured vs. helicopter's velocity, which are also indicative of the angle to wire; this correlation can be used to reduce false alarm rates.

Improved performance can be achieved by a system having a new, unique combination of features:

a. A stepped frequency waveform, to improve radar resolution.

b. High pulse repetition frequency (PRF) which still achieves unambiguous detection at the short range involved in this specific application.

c. Smaller than half wavelength antenna elements; the undesired reactive impedance component may be compensated accordingly, and to achieve impedance matching or as close to it as possible.

At each transmit frequency, an adequate compensation will be applied.

d. Low transmit power, achievable because of the combination of (a)-(c) above.

e. Low cost, fast, solid state elements for impedance compensation in (c), possible due to the low transmit power.

f. Modest sensitivity and dynamic range requirements

g. Low cost, lightweight radar system implementation, due to the low transmit 5 power and modest sensitivity and dynamic range requirements; the system may be integrated with the antenna into one unit, easy to install in a helicopter or light aircraft, and to remove therefrom.

Modest sensitivity requirements: At lower frequencies, the radar return is 10 higher (the target area increases at a rate proportional to the square of the wavelength); the broadside return from wires presents a large cross section. A pylon may be considered a monopole, half a dipole with the other half reflected off the ground; it is detected at a still lower frequency, thus presenting a larger area.

These considerations also cause the modest dynamic range requirements.

In one embodiment of the invention, the system operates alternatively at each of two frequencies, each adapted for efficient detection and identification of one of the two types of targets: wires and pylons.

In another embodiment, the system operates at the higher frequency to detect wires; when a large clutter return is received which is not linearly polarized (thus not a wire), then the system automatically turns to a lower frequency, to check whether polarization features appear at that frequency; if positive and the polarization is vertical—this is indicative of a pylon; the lower frequency may be adapted for identifying pylons up to 1 meter thick, for example.

If negative—the system may optionally turn to a still lower frequency, to identify pylons of 3 meter thickness for example.

Benefits of this system: pylons have a strong radar return, even at higher frequencies; at the higher frequency, a higher resolution is possible to reduce interference, to measure velocity of approach to target, etc.

Operating at both a high and low frequency allows to correlate the polarization properties at more than one frequency, thus to estimate the thickness of the pylon, if it is a pylon at all.

A possible problem in polarization measurements is that the ground clutter itself may exhibit some polarization effects (a different scattering in the horizontal and vertical polarizations). To correct for this effect, additional signal processing may be used to measure the average polarization of the clutter and to use these measurements as a threshold for a decision regarding the presence of a wire. That is, the presence of a wire in a radar range cell is expected to result in polarization characteristics that are different than those in surrounding cells.

Digital signal processing may be used to compute the expected time to collision and to warn the pilot if that time is less than a predefined threshold.

For example, a warning may be activated if there are 5 seconds to collision or less.

The doppler of the wires or pylon returns may be used to compute the velocity of approach (this may differ from the helicopter velocity); this, together with 20 the range to wires and pylons, may be used to compute the expected time to collision.

The doppler may be computed using Fast Fourier Transform (FFT) of the received signals.

Accordingly, further objectives of the present invention will become apparent to people skilled in the art upon reading the following detailed description and drawings.

### BRIEF DESCRIPTION OF DRAWINGS

Several embodiments of the invention will be disclosed, by way of example and with reference to the drawings in which:

FIG. 1A (Prior art) illustrates the wave reflection characteristics of wires, with the spatial directionality of reflection, and

FIG. 1B (Prior art) illustrates the polarization characteristics of wires

FIGS. 2A and 2B illustrate possible scenarios including reflecting wires and pylons

FIG. 3 details a possible installation of antennas on a helicopter and the antenna pattern of each element

FIG. 4 illustrates directional receive patterns when adjacent antenna elements are used in an interferometer configuration

FIG. 5A illustrates a system with transmit polarization control (linear polarization);

FIG. 5B illustrates a system with transmit circular polarization (a common unit can implement both the linear polarization of FIG. 5A and the circular polarization of FIG. 5B)

FIG. 6 illustrates a receiver system with polarization control—the IF signals can be combined at IF, or in digital form in a digital signal processor (DSP)

FIG. 7 illustrates a block diagram of the radar system

FIG. 8 illustrates antenna elements for a two-dimensional interferometer system

FIG. 9 illustrates a multi-element antenna array installation on a helicopter

FIG. 10 illustrates a conformal modular antenna/radar unit.

### MODES FOR CARRYING OUT THE INVENTION

Preferred embodiments of the current invention will now be described by way of example and with reference to the accompanying drawings.

Radar system or Wire detection apparatus are interchangeably used in this disclosure.

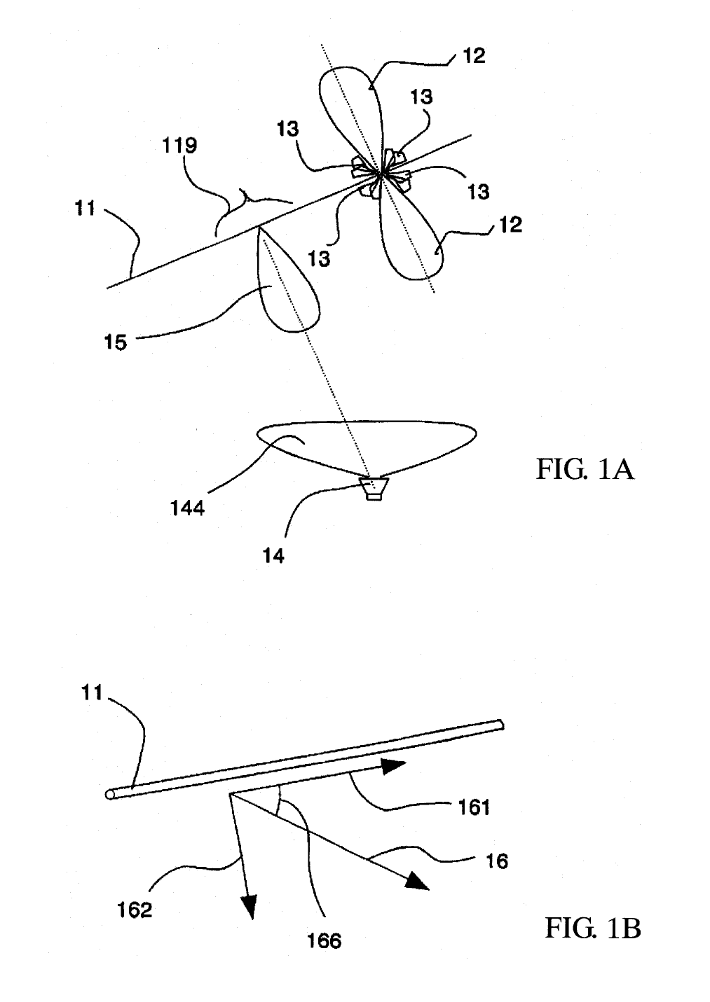

FIG. 1A (Prior art) illustrates the wave reflection characteristics of wires, with the spatial directionality of reflection, and FIG. 1B (Prior art) illustrates the polarization characteristics of wires.

For a suspended wire 11, waves from a electromagnetic waves transmitter 14 having a wide angle antenna pattern 144, there is a strong broadside return 12 in a direction normal to the wire 11, and sidelobes 13 in other directions.

The polarization radar in a helicopter can advantageously detect the strong broadside reflection from a section 119 of the wire 11.

In another embodiment, there may be a narrow pattern 144 of transmitter 14.

In a preferred embodiment, the transmitted waves have a wavelength more than six times longer than the diameter of wires to be detected and identified. This achieves a polarization effect in echoes from wires—stronger reflections for waves having a polarization in the direction of the waves.

For pylons detection and identification using waves polarization, the wire detection apparatus uses a wavelength longer than the width or diameter of the pylons.

The system may include a dual frequency radar, with a first frequency for detecting and identifying wires, and a second frequency for detecting and identifying pylons; the second frequency is lower than the first frequency.

Preferably the wire detection apparatus is implemented in a stepped frequency radar. Furthermore, the apparatus may use a high PRF radar for short range detection.

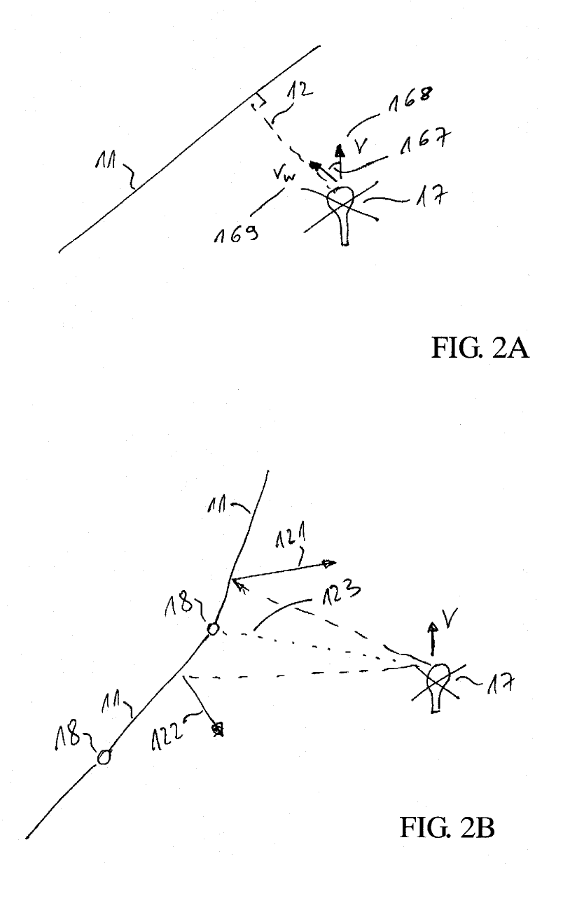

FIGS. 2A and 2B illustrate possible scenarios including reflecting wires and pylons.

In FIG. 2A, there is segment of wire 11 which is normal to the helicopter 17, this resulting in a strong broadside return 12 in a direction normal to the wire 11.

In FIG. 2B, however, the suspended wire 11 does not have a part normal to the helicopter 17; therefore the reflected waves 121, 122 from wires 11 are reflected away from the helicopter 17.

In this scenario, a pylon 18 may reflect waves 123 back toward the helicopter, thus allowing early detection and warning; it is desirable to distinguish the pylon as such, from ordinary ground clutter.

The ratio between the helicopter forward velocity V (168) and the velocity of approaching the wire Vw (169) may be indicative of the angle 167 to the wire—the direction to the wire; the angle 167 can be computed using the known trigonometric relationship

angle 167=arc(cos(Vw/V))

This value can be compared with other results, for example the interferometric value; this can increase the precision of the radar and reduce the false alarm rate.

Furthermore, it is possible to distinguish wires from pylons; the method uses the following criterion:

The return from a wire results in a value of 167 which is constant, whereas the angle 167 for a pylon changes with time as the helicopter 17 moves forward.

As the helicopter 17 is generally moving forward, to achieve a specific time of early warning (before the expected collision with a wire) a longer range is required. Hence the forward antenna 2 having a relatively narrow pattern or lobe 21.

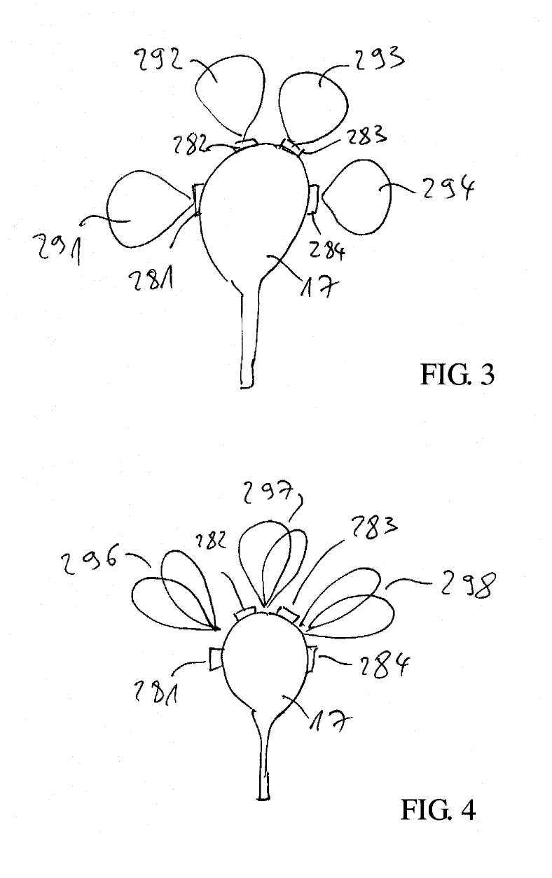

FIG. 3 details a possible installation of antennas on a helicopter and the antenna pattern of each of the antenna elements 281, 282, 283, 284 and their corresponding patterns 291, 292, 293, 294.

These are the transmit patterns for the antenna elements, when each element is used to transmit alone.

The wire detection apparatus may include means for interferometric direction finding in two dimensions, wherein the two dimensions comprise azimuth and elevation.

The apparatus may include antenna means having a bi-dimensional antenna array for implementing interferometry between adjacent elements of the antenna array.

In a preferred embodiment, antenna array elements are mounted on a curved convex surface, so as to allow the antenna elements to point in different directions.

FIG. 4 illustrates directional receive patterns when adjacent antenna elements are used in an interferometer configuration. In this illustrative example, there are formed directional receive patterns 296 (between elements 281 and 282), 297 (between elements 282 and 283), 298 (between elements 283 and 284).

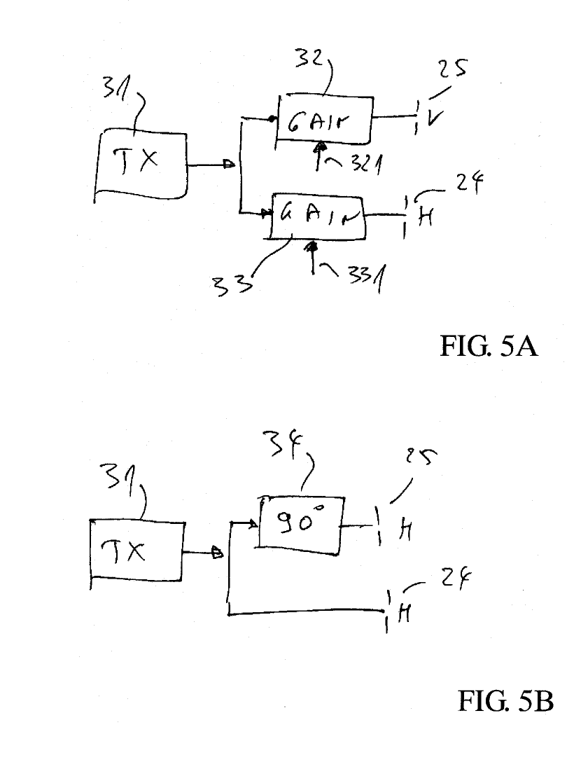

FIG. 5A illustrates a system with transmit polarization control (linear polarization);

FIG. 5B illustrates a system with transmit circular polarization (a common unit can implement both the linear polarization of FIG. 5A and the circular polarization of FIG. 5B).

A transmitter 31 is used with two gain control units 32 and 33. Each gain control unit can be implemented with a RF amplifier, with digitally controlled gain from the computer, through a gain control input 321, 331 respectively. Low power units 31, 32 and 33 can be used, because of the unique structure of the present radar: Low range (preferably less than 500 meters), simultaneous use of several antenna elements, wideband system in a Stepped Frequency Radar configuration.

The antenna unit with polarization capability may include linear antenna elements (i.e. dipoles) with vertical polarization 25, and horizontal polarization 24.

A phase shift unit 34, causes a 90 degrees phase shift in one output, for example the vertical output signal in the embodiment as illustrated.

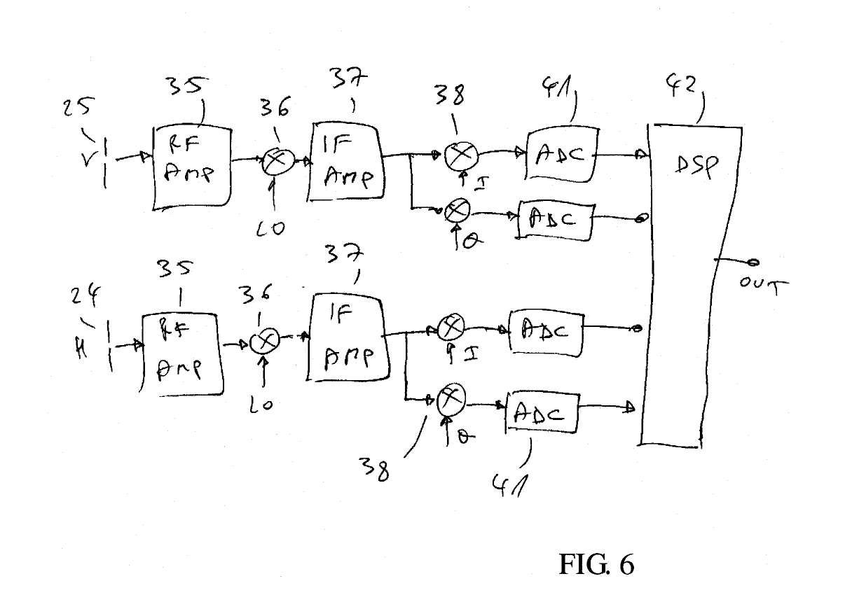

The RF circuits of FIGS. 5A, 5B are actually parts of one RF unit/transmit, different configurations which can be implemented under software control. FIG. 6 illustrates the receiver unit of the radar system with polarization control—the IF signals can be combined at IF, or in digital form in a digital signal processor (DSP).

If combined in phase—they form a linear polarization front end; if one is shifted 90 degrees—a circular polarization.

The receiver unit may include, in a preferred embodiment: antenna elements 24, 25; each antenna element connected to a RF amplifier 35, RF mixer 36 (first mixers), IF amplifier 37 and a pair of IF mixers 38—second mixer, coherent detector I/Q. The baseband signals out of mixers 38 are transferred to analog to digital converter (ADC) 41 and to the digital signal processor 42.

A Transmit/Receive (T/R) switch (not shown) connects either the transmitter 31 of FIGS. 5A, 5B or the receiver of FIG. 6 to the antenna elements 24, 25; how to implement this is known in the art and will not be detailed here, for the sake of clarity.

Actually, there may be more antenna elements in the system.

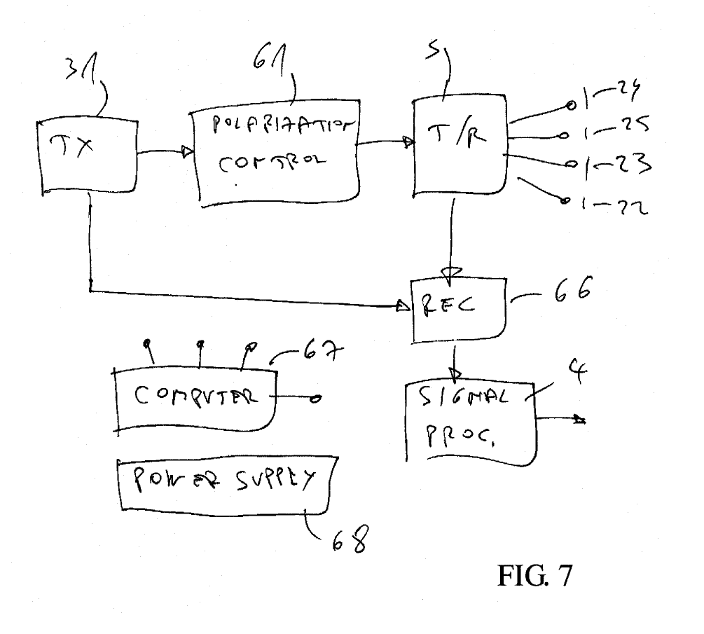

FIG. 7 illustrates a block diagram of the radar system.

This illustrates the complete system, parts of which were detailed above.

The system may include, for example: transmitter 31, polarization control unit 61, T/R switch 3, antenna elements 22, 23, 24, 25, receiver 66, signal processor 4, using a DSP for example, computer 67, power supply 68.

In a preferred embodiment, the transmitter 31 generates pulses of a stepped-frequency waveform. This can be used to achieve a high resolution radar.

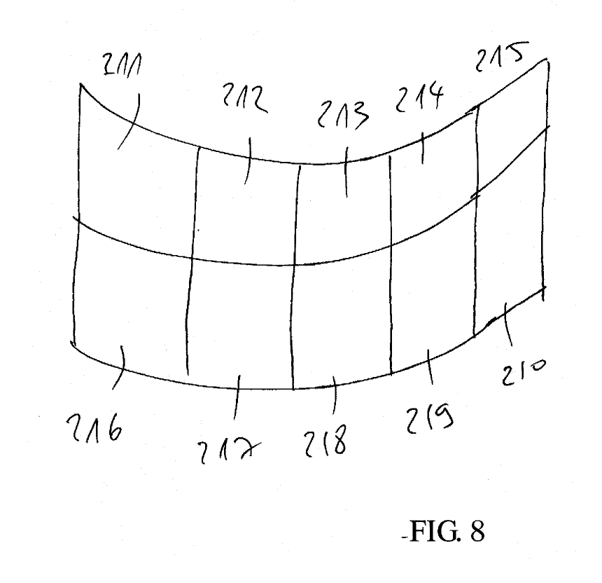

FIG. 8 illustrates antenna elements for a two-dimensional interferometer system. Each of the elements 210-219 has a polarization control capability as detailed elsewhere in the present disclosure.

Each element can be used alone to transmit a wide pattern, or two or more elements can be combined to transmit a more directional pattern, as required in any specific situation. For example, at high speed a narrower beam forward may be advantageous, to detect wires at longer distances. This may achieve a warning at a reasonable time prior to collision, to allow the pilot to take evasive action; at lower speeds, the lateral detection may become more important.

Two elements one above the other (i.e. elements 211, 216) may be combined at transmit to increase the gain in that direction.

At receive, elements may be combined to achieve directionality in azimuth, and optionally in elevation as well. Elements may be combined at RF, IF or in the DSP. Processing in the DSP is advantageous, as it is more flexible and precise and can be used to implement various beams as required.

The DSP can process phasors, relating to the amplitude and phase of the various signals.

A sparse array may be used; the array may include just two elements, such as 212+213 or 212+217; or three elements, such as 212+213+217, etc.

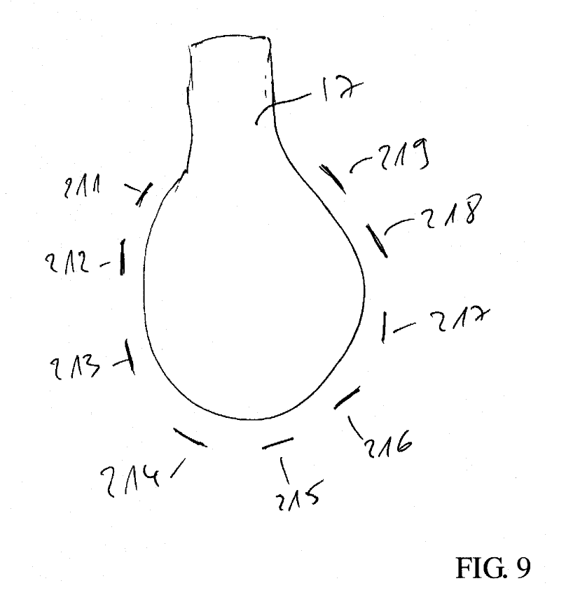

FIG. 9 illustrates a multi-element antenna array installation on a helicopter; each of the antenna elements 211-219 has a polarization control capability. The antenna elements may be mounted on the circumference of the helicopter body 17, as illustrated, for an enhanced wire detection capability on a horizontal (azimuth) plane.

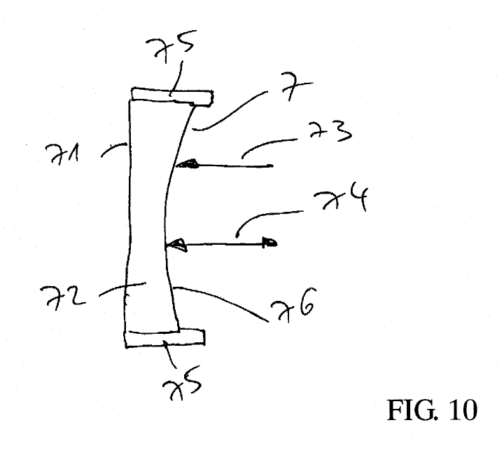

FIG. 10 illustrates a conformal modular antenna/radar unit.

The antenna/radar unit 7 may include, in a preferred embodiment: transmit/receive antenna aperture 71, radar circuits and housing 72, power input 73, data/signal input and output 74, fastening means 75, and a conformal surface 76, adapted to the helicopter body (or airplane body).

The wire detection system may be installed in a helicopter or in a light aircraft, for example, to provide a warning to prevent collision with wires or pylons.

A wires and pylons detection method

a. Transmitting RF waves having a controlled polarization;
b. Receiving RF returns (echoes) using controlled polarization antenna means;
c. Processing the received signals to identify echoes characteristic of wires or pylons;

d. Using a second (lower) frequency to identify pylons, if large echoes are received at a first frequency, which cannot be identified as wires.

In the above Method, it is possible to use a high PRF radar transmission for short range detection.

It will be recognized that the foregoing is but one example of an apparatus and method within the scope of the present invention and that various modifications will occur to those skilled in the art upon reading the disclosure set forth hereinbefore.

### INDUSTRIAL APPLICABILITY

The present invention relates to a novel system for detecting suspended wires using polarized radio waves.

According to one aspect of the invention, the system transmits multi-polarity waves, that is waves that have more than one linear polarization component. For each transmitted polarization, a receiver in the system analyzes the received echoes to detect linear polarized waves that are characteristic of wires.

In one embodiment, linearly polarized waves are transmitted and the polarization of received waves is measured. Linearly polarized echoes are indicative of a suspended wire in the area.

What is claimed is:

1. A wire detection apparatus comprising antenna means with transmitter and receiver means so devised as to form a pulsed radar system, further including polarization control means for controlling the polarization of waves transmitted and/or received through the antenna means, and processing means for identifying returns from wires according to wires' characteristic polarization echoes.

2. The wire detection apparatus according to claim 1, wherein the transmitted waves have a wavelength longer than the diameter of wires to be detected and identified.

3. The wire detection apparatus according to claim 1, wherein the transmitted waves have a wavelength more than six times longer than the diameter of wires to be detected and identified.

4. The wire detection apparatus according to claim 1, further including means for pylons detection and identification using waves polarization.

5. The wire detection apparatus according to claim 4, wherein the means for pylons detection and identification use waves having a wavelength longer than a diameter or width of the pylons to be detected.

6. The wire detection apparatus according to any of the claims 1 to 5, further including means for implementing a stepped frequency radar.

7. The wire detection apparatus according to any of the claims 1 to 6, further including means for implementing a dual frequency radar, including a first frequency for detecting and identifying wires, and a second frequency for detecting and identifying pylons, and wherein the second frequency is lower than the first frequency.

8. The wire detection apparatus according to any of the claims 1 to 7, further including means for implementing a high PRF radar for short range detection.

9. The wire detection apparatus according to any of the claims 1 to 8, further including means for interferometric direction finding in two dimensions, wherein the two dimensions comprise azimuth and elevation.

10. The wire detection apparatus according to any of the claims 1 to 9, wherein the antenna means comprise a bi-dimensional antenna array for implementing interferometry between 15 adjacent elements of the antenna array.

11. The wire detection apparatus according to claim 10, wherein the antenna array elements are mounted on a curved convex surface, so as to allow the antenna elements to point in different directions.

12. A wires and pylons detection method, comprising:
a. Transmitting RF waves having a controlled polarization;
b. Receiving RF returns (echoes) using controlled polarization antenna means;
c. Processing the received signals to identify echoes characteristic of wires or pylons;
d. Using a second (lower) frequency to identify pylons, if large echoes are received at a first frequency, which cannot be identified as wires.

13. The wires and pylons detection method according to claim 12, further using a high PRF radar transmission for short range detection.
